(19) United States
(12) Patent Application Publication
(10) Pub. No.: US 2024/0241040 A1
(43) Pub. Date: Jul. 18, 2024

(54) INSPECTION APPARATUS AND INSPECTION METHOD

(71) Applicant: SONY GROUP CORPORATION, Tokyo (JP)

(72) Inventors: Kentaro SAWADA, Tokyo (JP); Yasuyuki SATO, Tokyo (JP)

(73) Assignee: SONY GROUP CORPORATION, Tokyo (JP)

(21) Appl. No.: 18/562,475

(22) PCT Filed: Jan. 6, 2022
(86) PCT No.: PCT/JP2022/000240

§ 371 Date: Nov. 20, 2023

(30) Foreign Application Priority Data
May 27, 2021 (JP) 2021-089316

(51) Int. Cl. G01N 21/21; G01N 21/17; G01N 21/95

(52) U.S. Cl. CPC G01N 21/21; G01N 21/9515; G01N 2021/1772

(57) ABSTRACT

To provide an inspection apparatus and an inspection method that are suitable for inspection of a surface state of an inspection target surface. An inspection apparatus according to the present technology includes an irradiation unit, a polarization separation unit, an imaging unit, and a processing unit. The irradiation unit irradiates an inspection target surface with light. The polarization separation unit separates light obtained from the inspection target surface irradiated with the light into a plurality of polarization components in different polarization directions. The imaging unit includes a plurality of pixels that receives the light of the plurality of different polarization components and outputs a pixel signal, the light being separated by the polarization separation unit. The processing unit performs filtering processing on a polarization phase difference image at a predetermined spatial frequency, the polarization phase difference image being generated using the pixel signal output from the imaging unit.

### TECHNICAL FIELD

The present technology relates to an inspection apparatus and an inspection method for inspecting a surface of an inspection target surface.

### BACKGROUND ART

Conventionally, for example, defect inspection of a coated surface of a glossy curved surface of an automobile body or the like is visually performed by an inspector. At that time, the inspector changes illumination conditions by changing inspector's own observation positions with respect to the illumination, and detects defects such as scratches and irregularities.

In such defect inspection visually performed by the inspector, there is a case where variations in inspection accuracy occur depending on inspectors. Further, there is a case where inspection of a large-sized automobile needs a plurality of inspectors, and labor costs cause an increase in production costs. Therefore, it is desired to automate the defect inspection, and in recent years, an inspection apparatus for optically inspecting surface defects has been developed.

Patent Literature 1 describes that surface defects of organic thin films such as polarization films, which are used in organic thin-film photovoltaic cells, organic electro luminescence (EL) displays, liquid crystal displays, and the like, are optically detected.

Further, in a case where a plurality of types of defects is to be inspected, suitable illumination conditions vary depending on the characteristics of the defects. For example, in the detection of scratches, a technique of dark-field observation for detecting scattered light in a defective portion is effective. On the other hand, in the detection of dents, a technique of visualizing a change in shape of a surface by using a linear-shaped lighting such as a fluorescent lamp is effective. Thus, it is necessary to use a plurality of optical systems. Further, in order to perform a wide range of inspection, it is necessary to install a large number of cameras and lightings.

### CITATION LIST

### Patent Literature

Patent Literature 1: Japanese Patent Application Laid-open No. 2017-116294

### DISCLOSURE OF INVENTION

### Technical Problem

In defect detection of an inspection target surface, a technique of detecting a plurality of types of defects over a wide range is required.

In view of the circumstances as described above, it is an object of the present technology to provide an inspection apparatus and an inspection method that are suitable for inspection of a surface state of an inspection target surface.

### Solution to Problem

An inspection apparatus according to the present technology includes an irradiation unit, a polarization separation unit, an imaging unit, and a processing unit.

The irradiation unit irradiates an inspection target surface with light.

The polarization separation unit separates light obtained from the inspection target surface irradiated with the light into a plurality of polarization components in different polarization directions.

The imaging unit includes a plurality of pixels that receives the light of the plurality of different polarization components and outputs a pixel signal, the light being separated by the polarization separation unit.

The processing unit performs filtering processing on a polarization phase difference image at a predetermined spatial frequency, the polarization phase difference image being generated using the pixel signal output from the imaging unit.

According to such a configuration, it is possible to detect a plurality of different types of defects on the inspection target surface.

The inspection target surface may include a curved surface.

An area of a light emitting surface of the irradiation unit may be set to be larger than an area of the inspection target surface.

The processing unit may generate a degree-of-polarization image by using the pixel signal output from the imaging unit.

The polarization separation unit may include a plurality of polarizers that separates the light obtained from the inspection target surface into the polarization components in different polarization directions. The plurality of polarizers may be arranged on light receiving surfaces of the pixels respectively corresponding to the plurality of polarizers.

The polarizers may have polarization axes with an angle of a degrees, an angle of (α+45) degrees, an angle of (α+90) degrees, and an angle of (α+135) degrees, respectively.

The imaging unit may include a Scheimpflug optical system.

An inspection method according to the present technology includes: acquiring a pixel signal from an imaging unit including a plurality of pixels, the plurality of pixels receiving light obtained from an inspection target surface irradiated with light via a polarization separation unit and outputting the pixel signal, the polarization separation unit separating the light into a plurality of different polarization components; and performing filtering processing on a polarization phase difference image at a predetermined spatial frequency, the polarization phase difference image being generated using the pixel signal output from the imaging unit.

### BRIEF DESCRIPTION OF DRAWINGS

FIG. 1 is a schematic diagram showing an overall configuration of an inspection apparatus according to an embodiment of the present technology.

FIG. 2 is a schematic configuration diagram of an irradiation unit constituting a part of the inspection apparatus.

FIG. 3 is a schematic configuration diagram of a polarization camera constituting a part of the inspection apparatus.

FIG. 4 is a schematic configuration diagram of a polarization camera as another example.

FIG. 5 shows image examples acquired by the inspection apparatus.

FIG. 6 is a flowchart of an inspection method performed by a processing unit of the inspection apparatus.

### MODE(S) FOR CARRYING OUT THE INVENTION

Hereinafter, an embodiment according to the present technology will be described with reference to the drawings. An inspection apparatus of this embodiment can be used, for example, in defect inspection of a glossy coated surface (hereinafter, sometimes simply referred to as “coated surface”) of a vehicle body. The coated surface constituting the outer surface of the vehicle body is mainly made of resin.

The inspection apparatus is provided in, for example, a vehicle body coating line of an automobile manufacturing factory.

Defects in the coated surface of the vehicle body include, for example, projecting defects and recessed defects.

Projecting defects are, for example, seediness and sagging. Seediness refers to a phenomenon in which a coated film is raised (in a projecting shape) due to foreign matters such as fibers and dust mixed in a coating material or foreign matters attached after coating. Sagging refers to the fact that a coating material flows downward before being dried during coating of a vertical surface or an inclined surface, and a film thickness of the coating becomes partially uneven. Light reflected at a site of seediness or sagging tends to contain a small amount of scattering reflection components.

Recessed defects are, for example, cissing, dents, and scratches. Cissing is a hole that reaches a base surface of an object to be coated from a coated film surface due to repelling of the coating material. A dent is a depression generated in a coated film surface due to repelling of the coating material. A scratch is a linear flaw such as being scratched. Light reflected at a site of scratches mainly contains scattering reflection components, whereas light reflected at a site of cissing or dents tends to contain a small amount of scattering reflection components.

### [Configuration of Inspection Apparatus]

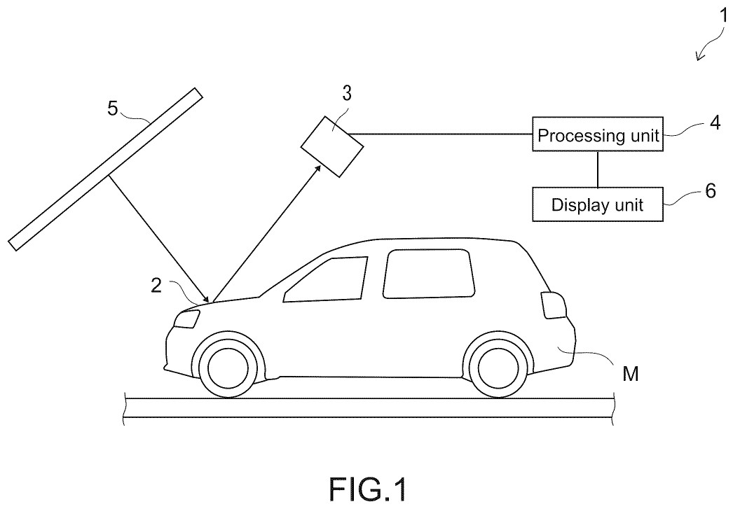

FIG. 1 is a schematic diagram showing an overall configuration of an inspection apparatus 1.

The inspection apparatus 1 inspects a defect located on a coated surface of a vehicle body M, which is an inspection target surface 2. In the example shown in FIG. 1, the inspection target surface 2 is a coated surface of a hood of the vehicle body M.

The inspection apparatus 1 includes an irradiation unit 5, a polarization camera 3, a processing unit 4, and a display unit 6.

In the defect inspection performed by the inspection apparatus 1, the inspection target surface 2 is imaged by the polarization camera 3 in a state in which the inspection target surface 2 is irradiated with light from the irradiation unit 5. A change in the state of the light (a change in polarization state) due to reflection on the inspection target surface 2 is observed in the imaging result, so that defect inspection for the coated surface is performed. This will be described below in detail.

### (Irradiation Unit)

The irradiation unit 5 is a surface illumination device for irradiating the inspection target surface 2 with light. Light emitted from the irradiation unit 5 may be polarized light having a known polarization state, such as circularly polarized light or linearly polarized light, or may be unpolarized light. Note that the circularly polarized light includes elliptically polarized light. The light from the irradiation unit 5 is obliquely incident on the inspection target surface 2.

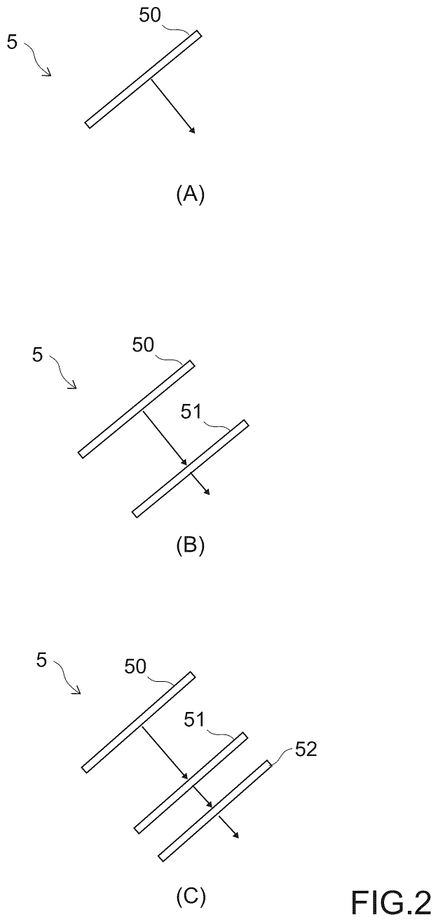

(A) to (C) of FIG. 2 each show a configuration example of the irradiation unit 5.

As shown in (A) of FIG. 2, if the irradiation unit 5 emits unpolarized light, the irradiation unit 5 includes, for example, a light source 50. The light source 50 is, for example, a white light source.

As shown in (B) of FIG. 2, if the irradiation unit 5 emits linearly polarized light, the irradiation unit 5 includes a light source 50 and a polarization plate 51. The polarization plate 51 converts unpolarized light coming from the light source 50 into linearly polarized light.

As shown in (C) of FIG. 2, if the irradiation unit 5 emits circularly polarized light, the irradiation unit 5 includes a light source 50, a polarization plate 51, and a quarter-wave plate 52. The polarization plate 51 converts unpolarized light emitted from the light source 50 into linearly polarized light, and the quarter-wave plate 52 converts the linearly polarized light into circularly polarized light.

The light source 50 includes, for example, a diffuser plate arranged on an LED substrate on which a plurality of LEDs is arranged at regular intervals on a wiring board, and is formed into a panel-like shape. Further, the light source 50 may be formed by arranging a diffuser plate on a group of fluorescent lamps in which a plurality of elongated fluorescent lamps is arranged. The light source 50 is not particularly limited.

Here, the body of the vehicle body M, which serves as the inspection target surface, typically includes not only a flat surface having zero curvatures, but also a surface (curved surface) having a curvature. Further, the body of the vehicle body M has different curvatures depending on sites and have different inclinations of the surface depending on the sites.

Here, “having a curvature” indicates that the curvature is other than zero.

In consideration of a light reflection direction due to the curved shape of the body of the vehicle body M, it is favorable to set an area of a light emitting surface of the irradiation unit 5 to be sufficiently large. The area of the light emitting surface of the irradiation unit 5 is increased such that the polarization camera 3 is positioned on the optical axis of the light emitted from the irradiation unit 5 to cause regular reflection (specular reflection) on the inspection target surface 2. This makes it possible to inspect the curved surface by a regular reflection optical system even if the inspection target surface 2 has a curved surface. In such a manner, increasing the area of the light emitting surface of the irradiation unit 5 makes it possible to arrange the irradiation unit 5 and the polarization camera 3 in a regular reflection arrangement.

In the present technology, a defect of the inspection target surface 2 is detected by observing a change in polarization state due to reflection of light on the inspection target surface 2. Thus, increasing the area of the light emitting surface of the irradiation unit 5 and arranging the irradiation unit 5 and the polarization camera 3 in a regular reflection arrangement makes it possible to inspect the curved surface by a regular reflection optical system even if the inspection target surface 2 has a curved surface, and possible to enhance the accuracy of defect detection.

In the example in which the hood shown in FIG. 1 is the inspection target surface, if a dimension of the vehicle body M in a width direction is 170 cm, the size of the light emitting surface of the irradiation unit 5 in the horizontal direction and the size thereof in the vertical direction can be set to approximately 200 cm to 250 cm. In such a manner, the size of the light emitting surface of the irradiation unit 5 can be made larger than that of the inspection target surface. Note that the numerical values are merely examples, and the size is not limited thereto.

Note that the inspection is performed using polarization in the present technology, and thus the highest sensitivity is obtained when the irradiation unit and the polarization camera (imaging unit) are arranged at an angle centered on the Brewster's angle. However, depending on the arrangement of the devices, inspection at an arrangement angle other than the angle centered on the Brewster's angle can also be achieved.

### (Polarization Camera)

The polarization camera 3 can acquire polarization information of a subject (inspection target surface). The number of polarization cameras 3 to be installed is appropriately set according to the size of the inspection target surface, and one or more cameras are installed.

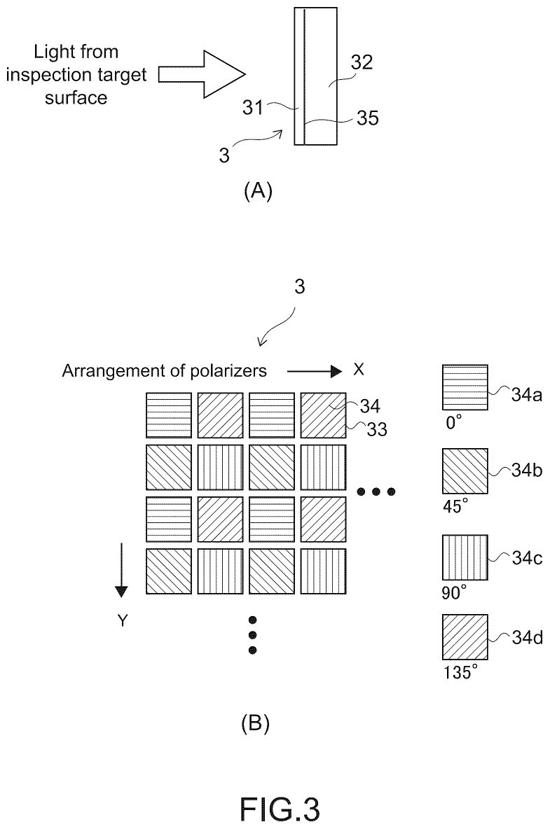

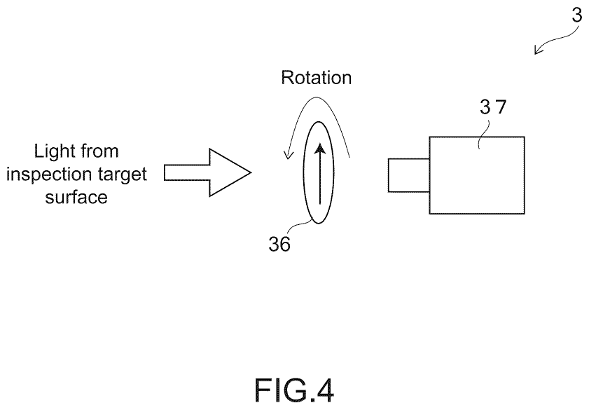

FIGS. 3 and 4 are schematic diagrams each showing an example of the structure of the polarization camera 3. The polarization camera having any configuration of FIGS. 3 and 4 may be used.

(A) of FIG. 3 is a schematic diagram showing an example of the polarization camera 3.

As shown in (A) of FIG. 3, the polarization camera 3 includes an image sensor 32 as an imaging unit, and a polarization unit 31 as a polarization separation unit. The polarization unit 31 includes a plurality of polarizers 34. Here, a configuration without a color filter will be described, but the polarization camera 3 may include a color filter.

(B) of FIG. 3 is a schematic diagram showing an example of arrangement of light receiving polarizers, in which the polarizers 34 are arranged to correspond to pixels 33 of the image sensor 32. (B) of FIG. 3 schematically shows a plurality of pixels 33 on which the polarizers 34 (polarization unit 31) are arranged.

The image sensor 32 includes the plurality of pixels 33 each capable of outputting a pixel signal. As shown in (B) of FIG. 3, the plurality of pixels 33 is arranged in a two-dimensional matrix along two directions (X direction and Y direction) orthogonal to each other on the light receiving surface of the image sensor 32. In the image sensor 32, the intensity of the incident light that enters each pixel 33 is detected, and a result of the detection is output as a pixel signal.

The specific configuration of the image sensor 32 is not limited. For example, a complementary metal-oxide semiconductor (CMOS) sensor, a charge coupled device (CCD) sensor, or the like may be appropriately used.

The polarization unit 31 separates the light (reflected light), which is obtained from the inspection target surface 2 irradiated with the light from the irradiation unit 5, into a plurality of different polarization components. Light separated into different polarization components is incident on the pixels 33 of the image sensor 32.

More specifically, the polarization unit 31 includes the plurality of polarizers 34 arranged on a light receiving surface 35 side of the image sensor 32. The light (reflected light) obtained from the inspection target surface 2 is incident on the light receiving surface 35 of the image sensor 32 via the polarization unit 31. The intensity (brightness) of an optical image located at a position of each pixel 33 is then detected as a pixel signal. This makes it possible to perform image observation of the inspection target surface 2, for example.

Each polarizer 34 has a size substantially equal to the size of each of the plurality of pixels 33 of the image sensor 32, and is arranged to correspond to each of the plurality of pixels 33 of the image sensor 32. In other words, the polarization unit 31 is configured such that one polarizer 34 is arranged on the light receiving surface 35 side of one pixel 33. Therefore, the number of multiple polarizers 34 and the number of multiple pixels 33 are equal to each other.

The plurality of polarizers 34 has respective polarization axes in different polarization directions. For example, when light enters a certain polarizer 34, a polarization component (linearly polarized light) having a polarization direction parallel to the polarization axis of that polarizer 34 is extracted.

In (B) of FIG. 3, a polarizer 34a has a polarization axis in a polarization direction with an angle of α degrees. The polarization direction with the angle of α degrees is defined as a reference direction. In this embodiment, the angle of α degrees is assumed as 0 degrees.

A polarizer 34b has a polarization axis in a polarization direction with an angle of (α+45) degrees. In other words, the polarizer 34b has a polarization axis with an angle of (α+45) degrees, which is rotated by 45 degrees in a predetermined direction from the reference direction.

A polarizer 34c has a polarization axis in a polarization direction with an angle of (α+90) degrees. In other words, the polarizer 34c has a polarization axis with an angle of 90 degrees, which is rotated by 90 degrees in a predetermined direction from the reference direction.

A polarizer 34d has a polarization axis in a polarization direction with an angle of (α+135) degrees. In other words, the polarizer 34d has a polarization axis with an angle of 135 degrees, which is rotated by 135 degrees in a predetermined direction from the reference direction.

In the polarization camera 3, the light obtained from the inspection target surface 2 is incident on the polarization unit 31 (the plurality of polarizers 34). The plurality of polarizers 34 extracts polarization components parallel to the respective polarization axes from the incident light, and causes the extracted polarization components to enter the corresponding pixels 33. It can also be said that the plurality of polarizers 34 controls the polarization directions of the light traveling toward the corresponding pixels 33.

The plurality of polarizers 34 is formed on the light receiving surface 35 side of the respective pixels 33 according to, for example, a process of generating the plurality of pixels 33 of the image sensor 32. In other words, the polarization unit 31 is formed of the plurality of polarizers 34 formed on the plurality of pixels 33. The specific configuration of the polarizer 34 is not limited. A polarizer 34 using a wire grid, a liquid crystal element, a polarization film, or the like may be appropriately used.

As described above, in the polarization camera 3 shown in FIG. 3, the pixel signals in different polarization directions, that is, the polarization images, can be acquired from the pixel signals obtained by one imaging.

Further, the polarization camera may have a configuration shown in FIG. 4. FIG. 4 is a schematic diagram showing an example of another polarization camera 3.

The polarization camera 3 shown in FIG. 4 includes an image sensor 37 as an imaging unit, and a rotatable polarization plate 36 as a polarization separation unit. Here, a configuration without a color filter will be described, but the polarization camera 3 may include a color filter.

The image sensor 37 includes a plurality of pixels 33 each capable of outputting a pixel signal. A CMOS sensor, a CCD sensor, or the like may be appropriately used as the image sensor 37.

The rotatable polarization plate 36 is provided on a light receiving surface side of the polarization camera 3. By rotation of the polarization plate 36, the light obtained from the inspection target surface 2 is separated into a plurality of polarization components in different polarization directions in a time-division manner. The separated light is incident on the pixels of the image sensor 37, and a pixel signal is output from each pixel.

In the polarization camera 3 shown in FIG. 4, a plurality of images is captured with the polarization plate 36 being rotated, and a plurality of polarization images in different polarization directions is acquired.

Note that, from the viewpoint of shortening an inspection time, it is more favorable to use the polarization camera 3 having the structure shown in FIG. 3. In order to acquire a plurality of pixel signals in different polarization directions, the polarization camera 3 shown in FIG. 4 requires a plurality of images captured by rotating the polarization plate 36, whereas the polarization camera 3 shown in FIG. 3 requires one-time imaging. As described above, use of the polarization camera 3 shown in FIG. 3 makes it possible to shorten the inspection time, and an efficient inspection can be performed.

In the polarization camera 3, the image sensor 32 captures an image of the inspection target surface via a lens (an objective lens or an imaging lens) (not shown).

The polarization camera 3 may be a camera including a Scheimpflug optical system.

In the present technology, in order to observe a change in state of light due to reflection (change in polarization state), it is favorable to arrange the irradiation unit 5 and the polarization camera 3 in a regular reflection arrangement, and the irradiation unit 5 is arranged such that light from the irradiation unit 5 obliquely enters the inspection target surface 2. At that time, there is a case of being out of focus in a depth direction due to the influence of the depth of focus of the lens, but use of a camera including a Scheimpflug optical system makes it possible to acquire a high-definition image in a wide range in the depth direction. For example, if the field of view is obliquely provided, defocus between the near side and the far side in the field of view occurs due to the depth of field of the camera. This can be avoided by the Scheimpflug optical system.

The camera including the Scheimpflug optical system includes, for example, a movable mechanism that changes an angle between a lens and a horizontal plane such that the inspection target surface, the main surface of the lens, and the light receiving surface of the image sensor 32 satisfy Scheimpflug conditions.

### (Display Unit)

The display unit 6 displays, for example, an image of the inspection target surface 2, which is processed by the processing unit 4 so as to be an image suitable for defect inspection. For example, a display apparatus such as a liquid crystal monitor is used as the display unit 6. The display unit 6 is installed in the vicinity of the vehicle body coating line. Thus, the inspector can perform defect inspection of the inspection target surface 2 while checking the image displayed on the display unit 6.

### (Processing Unit)

The processing unit 4 calculates a polarization parameter by using the pixel signals of the respective pixels 33, which are output from the image sensor 32. The processing unit 4 uses the polarization parameter to process pixel signals so as to provide an image suitable for defect inspection of the inspection target surface 2.

In the present technology, a polarization phase difference image that is obtained by using the polarization parameter is subjected to filtering processing at a predetermined spatial frequency to generate a spatial frequency optimized image. On the basis of the spatial frequency optimized image, a plurality of types of defects on the inspection target surface 2 can be detected from one image simultaneously and highly accurately.

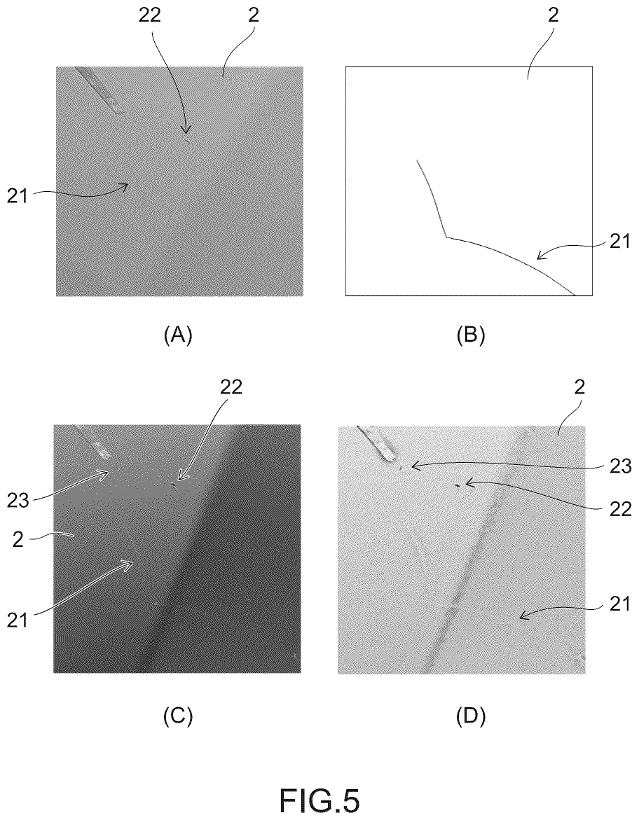

Hereinafter, the processing performed by the processing unit 4 will be described with reference to FIG. 5.

(A) to (D) of FIG. 5 are images generated by using pixel signals of a single inspection target surface 2. The inspection target surface 2 has a curved surface. Further, the inspection target surface 2 has three types of defects, i.e., a seediness 22, a scratch 21, and a dent 23.

Note that a linear object with a width, which is located at the upper left in (A), (C), and (D) of FIG. 5, is a checking tape used to check the position of the dent and does not indicate the original shape of the inspection target surface or a defect. The “original shape of the inspection target surface” indicates the shape of the inspection target surface with no defects.
(A) of FIG. 5 is an image that is obtained by averaging four polarization images based on the pixel signals of the respective pixels 33 corresponding to the polarizers 34a to 34d, the pixel signals being output from the image sensor 32.
(B) of FIG. 5 is a degree-of-polarization image in which a distribution of the degree of polarization (DoP) that is a polarization parameter calculated by using the pixel signals of the pixels 33 is visualized, the pixel signals being output from the image sensor 32. The degree of polarization will be described later.
(C) of FIG. 5 is a polarization phase difference image in which a distribution of a polarization phase difference that is a polarization parameter calculated by using the pixel signals of the pixels 33 is visualized, the pixel signals being output from the image sensor 32. The polarization phase difference will be described later.
(D) of FIG. 5 is a spatial frequency optimized image that is obtained after performing filtering processing on the polarization phase difference image shown in (C) of FIG. 5 at a predetermined spatial frequency. The filtering processing will be described later.

In (A) of FIG. 5, there is a gradation region that bisects the whole into two of the right and left. This is because a difference in the inclination of the surface, which is the original shape of the inspection target surface 2, appears as the shading of the color. In (A) of FIG. 5, the scratch 21 and the seediness 22 can be recognized, whereas the dent 23 is difficult to recognize.

In the present technology, filtering processing is performed on the polarization phase difference image at a predetermined spatial frequency, and thus it is possible to easily detect a plurality of different types of defects such as the scratch 21, the seediness 22, and the dent 23 from one image even if the inspection target surface 2 has a curved surface. This will be described below in detail.

The processing unit 4 calculates a Stokes vector S (S0, S1, S2) for each pixel 33 by using the pixel signal for each pixel 33, which is output from the image sensor 32, according to Equation (1) below. The Stokes vector S is a polarization parameter.

In Equation (1), I₀ represents luminance data (pixel signal) in the pixel 33 corresponding to the polarizer 34a in which the polarization axis in the reference direction is set. I₄₅ represents luminance data (pixel signal) in the pixel 33 corresponding to the polarizer 34b in which the polarization axis rotated by 45 degrees in a predetermined direction from the reference direction is set. I₉₀ represents luminance data (pixel signal) in the pixel 33 corresponding to the polarizer 34c in which the polarization axis rotated by 90 degrees in a predetermined direction from the reference direction is set. I₁₃₅ represents luminance data (pixel signal) in the pixel 33 corresponding to the polarizer 34d in which the polarization axis rotated by 135 degrees in a predetermined direction from the reference direction is set. The luminance data is data of intensity (brightness).

$$\begin{matrix}[ Math . 1 ] & \\ [ \begin{matrix}{S}_{0} \\ {S}_{1} \\ {S}_{2}\end{matrix} ] = [ \begin{matrix}( {I}_{0} + {I}_{45} + {I}_{90} + {I}_{135} ) / 2 \\ {I}_{0} - {I}_{90} \\ {I}_{45} - {I}_{135}\end{matrix} ] & ( 1 )\end{matrix}$$

The processing unit 4 calculates the degree of polarization DoP by Equation (2) below, using the Stokes vectors obtained above. The degree of polarization DoP is a polarization parameter. The processing unit 4 generates a degree-of-polarization image in which a distribution of the polarization degree DoP is visualized.

$$\begin{matrix}[ Math . 2 ] & \\ DoP = \frac{\sqrt{{S}_{1}^{2} + {S}_{2}^{2}}}{{S}_{0}} & ( 2 )\end{matrix}$$

As shown in (B) of FIG. 5, the scratch 21 can be clearly recognized in the degree-of-polarization image in which the distribution of the polarization degree DoP calculated by Equation (2) above is visualized. Since light obtained from the site of the scratch 21 mainly contains scattering reflection components, observation of the degree of polarization is suitable for detection of the scratch 21. On the other hand, in the observation of the degree of polarization, it is difficult to detect the seediness 22 or the dent 23.

The processing unit 4 calculates a polarization phase difference Φ by Equation (3) below, using the Stokes vectors obtained above. The polarization phase difference Φ is a polarization parameter. The processing unit 4 generates a phase difference image in which the distribution of the polarization phase difference Φ is visualized.

$$\begin{matrix}[ Math . 3 ] & \\ ϕ = \frac{1}{2} {tan}^{- 1} ( \frac{{S}_{2}}{{S}_{1}} ) & ( 3 )\end{matrix}$$

As shown in (C) of FIG. 5, the scratch 21, the seediness 22, and the dent 23 can be recognized in the phase difference image in which the distribution of the polarization phase difference Φ calculated by the Equation (3) above is visualized.

In the light obtained from the sites of irregularities such as the scratch 21, the seediness 22, and the dent 23, a reflection angle of specular reflection changes, and thus the observation of the polarization phase difference is suitable for the detection of the scratch 21, the seediness 22, and the dent 23.

However, as shown in (C) of FIG. 5, if the inspection target surface 2 has a curved surface, a color representing the original curved shape of the inspection target surface 2 (a gradation region that bisects the whole into the right and left in (C) of FIG. 5) appears. Therefore, it is difficult to distinguish between a change in reflection angle of specular reflection, which is caused by the original shape of the inspection target surface 2, and a change in reflection angle caused by a defect.

In contrast, in the present technology, the processing unit 4 performs filtering processing on the polarization phase difference image at a predetermined spatial frequency to generate a spatial frequency optimized image.

More specifically, a high-pass filter is used to leave a component having a high spatial frequency included in the polarization phase difference image and remove a portion having a low spatial frequency. This makes it possible to separate the change in reflection angle of specular reflection, which is caused by the original shape of the inspection target surface 2, from the change in reflection angle caused by a defect.

A cutoff frequency at the time of filtering processing can be appropriately set in accordance with the curvature of the inspection target surface 2. In the present technology, defect inspection can be performed without changing the relative positions of the irradiation unit 5 and the polarization camera 3. Therefore, a region of the inspection target surface can be grasped in advance, and thus the cutoff frequency can be set in advance in accordance with the curvature of the inspection target surface.

As shown in (D) of FIG. 5, in the spatial frequency optimized image obtained by the filtering processing, a boundary portion between the surfaces with different inclinations is a portion having a sudden change in brightness, that is, a portion having a high spatial frequency, from the viewpoint of only the original shape of the inspection target surface 2. Thus, the boundary portion appears as a substantially straight line extending in the vertical direction so as to bisects the image into the right and left. On the other hand, a portion other than the boundary is a portion having a low spatial frequency, and thus does not appear on the image. In such a manner, the spatial frequency optimized image is an image in which at least part of the information related to the original shape of the inspection target surface 2 disappears. Thus, the spatial frequency optimized image is an image in which defects each having a locally large change, such as the scratch 21, the seediness 22, and the dent 23, are more conspicuous. Therefore, a defect can be recognized more clearly, and the detection accuracy of a defect is improved.

As described above, if the filtering processing is performed on the phase difference image at a predetermined spatial frequency, the change in reflection angle of specular reflection due to the original shape of the inspection target surface 2 is easily distinguished from the change in reflection angle due to a defect, which is a site having a small uneven difference locally located, such as the scratch 21, the seediness 22, or the dent 23. This makes it possible to improve the detection accuracy of a defect.

As described above, in the present technology, the polarization phase difference image that is obtained by using the pixel signals output from the image sensor 32 is subjected to filtering processing at a predetermined spatial frequency. Thus, even if the inspection target surface 2 has a curved shape, it is possible to detect a plurality of different types of defects such as the scratch 21, the seediness 22, and the dent 23 highly accurately and simultaneously from one spatial frequency optimized image. This makes it possible to shorten an inspection time, and greatly improve an inspection efficiency.

Furthermore, in this embodiment, the light emitting surface of the irradiation unit 5 has a large area, and thus it is possible to enlarge a region that can be inspected. Therefore, it is possible to detect a plurality of types of defects in a wide range, and it is possible to shorten an inspection time, for example, even for a large inspection target such as the vehicle body M.

Note that the scratch, the seediness, and the dent have been described here as examples of the defects, but sagging and cissing can also be detected in a similar manner.

Further, in addition to the observation of the spatial frequency optimized image, the observation of the degree-of-polarization image (see (B) of FIG. 5) may be performed together. This makes it possible to further improve the detection accuracy of scratches.

The present technology is an inspection apparatus suitable for inspection of a surface state of an inspection target surface, and is capable of inspecting a plurality of different types of defects only by performing waveform processing of pixel signals obtained using a polarization camera, without moving the polarization camera or the irradiation unit. It is not necessary to set illumination conditions suitable for respective different defects in order to inspect a plurality of types of defects as in a conventional case. Thus, the present technology can reduce the number of optical systems and lightings used in the inspection process.

Further, the defect inspection is performed by looking at the spatial frequency optimized image, and thus it is possible to suppress the occurrence of inspection errors, inspection omissions, and the like due to variations in inspection by different inspectors as compared with conventional visual defect inspection, and it is possible to perform a stable defect inspection operation with high inspection accuracy.

### [Inspection Method]

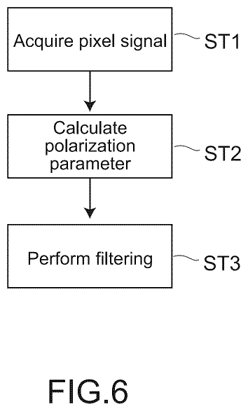

An inspection method of the present technology, which uses the inspection apparatus 1, will be described with reference to the flow of FIG. 6.

As shown in FIG. 6, the processing unit 4 acquires a pixel signal of each pixel 33, which is output from the image sensor 32 of the polarization camera 3 that captures an image of the inspection target surface 2 irradiated with light from the irradiation unit 5 (ST1).

Next, the processing unit 4 uses the acquired pixel signal to calculate polarization parameters such as the Stokes vector S, the polarization phase difference Φ, and the degree of polarization DoP (ST2).

Next, the processing unit 4 performs filtering processing on the polarization phase difference image, which is based on the calculated polarization phase difference Φ, at a predetermined spatial frequency (ST3), and generates a spatial frequency optimized image.

The generated spatial frequency optimized image is output to the display unit 6 and displayed on the display unit 6. An inspector observes the spatial frequency optimized image to perform defect inspection.

Further, the processing unit 4 may generate a degree-of-polarization image based on the calculated degree of polarization DoP, in addition to the spatial frequency optimized image. The spatial frequency optimized image and the degree-of-polarization image are output to the display unit 6 and displayed on the display unit 6. An inspector may observe those images to perform defect inspection.

The embodiment of the present technology is not limited to the embodiment described above, and various modifications can be made thereto without departing from the gist of the present technology.

For example, in the embodiment described above, an example in which the inspection target surface is a glossy coated surface of a vehicle body has been described, but the present technology is not limited thereto. For example, the present technology is also applicable to surface inspection of any glossy coated surface, a resin molded article, a semiconductor wafer, a transparent component such as glass or resin, a tablet, or the like.

Further, in the embodiment described above, a case where the inspection target surface is a curved surface has been described as an example, but the present technology may be applied to inspection of a flat surface. However, as described above, the present technology makes it possible to distinguish between a change in reflection angle of reflected light, which is caused by the original shape of the inspection target surface, and a change in reflection angle, which is caused by a defect, by the filtering processing. Thus, the present technology is particularly effective for defect inspection of an inspection target surface having a curved surface.

The present technology can have the following configurations.
(1) An inspection apparatus, including:
   an irradiation unit that irradiates an inspection target surface with light;
   a polarization separation unit that separates light obtained from the inspection target surface irradiated with the light into a plurality of polarization components in different polarization directions;
   an imaging unit including a plurality of pixels that receives the light of the plurality of different polarization components and outputs a pixel signal, the light being separated by the polarization separation unit; and
   a processing unit that performs filtering processing on a polarization phase difference image at a predetermined spatial frequency, the polarization phase difference image being generated using the pixel signal output from the imaging unit.
(2) The inspection apparatus according to (1), in which
   the inspection target surface includes a curved surface.
(3) The inspection apparatus according to (1) or (2), in which
   an area of a light emitting surface of the irradiation unit is set to be larger than an area of the inspection target surface.
(4) The inspection apparatus according to any one of (1) to (3), in which
   the processing unit generates a degree-of-polarization image by using the pixel signal output from the imaging unit.
(5) The inspection apparatus according to any one of (1) to (4), in which
   the polarization separation unit includes a plurality of polarizers that separates the light obtained from the inspection target surface into the polarization components in different polarization directions, and
   the plurality of polarizers is arranged on light receiving surfaces of the pixels respectively corresponding to the plurality of polarizers.
(6) The inspection apparatus according to (5), in which
   the polarizers have polarization axes with an angle of α degrees, an angle of (α+45) degrees, an angle of (α+90) degrees, and an angle of (α+135) degrees, respectively.
(7) The inspection apparatus according to any one of (1) to (6), in which
   the imaging unit includes a Scheimpflug optical system.
(8) An inspection method, including:
   acquiring a pixel signal from an imaging unit including a plurality of pixels, the plurality of pixels receiving light obtained from an inspection target surface irradiated with light via a polarization separation unit and outputting the pixel signal, the polarization separation unit separating the light into a plurality of different polarization components; and
   performing filtering processing on a polarization phase difference image at a predetermined spatial frequency, the polarization phase difference image being generated using the pixel signal output from the imaging unit.

### REFERENCE SIGNS LIST

1 inspection apparatus
2 inspection target surface
4 processing unit
5 irradiation unit
31 polarization unit (polarization separation unit)
32 image sensor (imaging unit)
36 rotatable polarization plate (polarization separation unit)
37 image sensor (imaging unit)

What is claimed is:

1. An inspection apparatus, comprising:
an irradiation unit that irradiates an inspection target surface with light;
a polarization separation unit that separates light obtained from the inspection target surface irradiated with the light into a plurality of polarization components in different polarization directions;
an imaging unit including a plurality of pixels that receives the light of the plurality of different polarization components and outputs a pixel signal, the light being separated by the polarization separation unit; and
a processing unit that performs filtering processing on a polarization phase difference image at a predetermined spatial frequency, the polarization phase difference image being generated using the pixel signal output from the imaging unit.

2. The inspection apparatus according to claim 1, wherein
the inspection target surface includes a curved surface.

3. The inspection apparatus according to claim 1, wherein
an area of a light emitting surface of the irradiation unit is set to be larger than an area of the inspection target surface.

4. The inspection apparatus according to claim 1, wherein
the processing unit generates a degree-of-polarization image by using the pixel signal output from the imaging unit.

5. The inspection apparatus according to claim 1, wherein
the polarization separation unit includes a plurality of polarizers that separates the light obtained from the inspection target surface into the polarization components in different polarization directions, and
the plurality of polarizers is arranged on light receiving surfaces of the pixels respectively corresponding to the plurality of polarizers.

6. The inspection apparatus according to claim 5, wherein
the polarizers have polarization axes with an angle of α degrees, an angle of (α+45) degrees, an angle of (α+90) degrees, and an angle of (α+135) degrees, respectively.

7. The inspection apparatus according to claim 1, wherein
the imaging unit includes a Scheimpflug optical system.

8. An inspection method, comprising:
acquiring a pixel signal from an imaging unit including a plurality of pixels, the plurality of pixels receiving light obtained from an inspection target surface irradiated with light via a polarization separation unit and outputting the pixel signal, the polarization separation unit separating the light into a plurality of different polarization components; and
performing filtering processing on a polarization phase difference image at a predetermined spatial frequency, the polarization phase difference image being generated using the pixel signal output from the imaging unit.
